(19) United States
(12) Patent Application Publication
(10) Pub. No.: US 2013/0052980 A1
(43) Pub. Date: Feb. 28, 2013

(54) PAGER HAVING A CALL-BACK FUNCTION

(71) Applicants: SHIN-TSENG YEH, New Taipei city (TW); Yi-Ming Huang, New Taipei City (TW)

(72) Inventors: SHIN-TSENG YEH, New Taipei city (TW); Yi-Ming Huang, New Taipei City (TW)

(73) Assignee: Unication Group/Unication Co., LTD., New Taipei City (TW)

(21) Appl. No.: 13/527,385

(22) Filed: Jun. 19, 2012

(30) Foreign Application Priority Data
Aug. 31, 2011 (TW) 100131414

(51) Int. Cl. H04W 4/16; H04W 4/22; H04W 4/14

(52) U.S. Cl. 455/404.1

(57) ABSTRACT

A pager having a call-back function is capable of transmitting an acknowledgement (Ack) of a paging message to a console via a Global System for Mobile Communications (GSM) network, and includes an automatic linking program for linking the pager to at least a remote communication device via the GSM network to enable a two-way communication, based on a communication address designated in the received paging message or pre-stored in the pager, and therefore improve communication ability of the pager.

### BACKGROUND OF THE INVENTION

1. Field of the Invention

The present invention relates to a pager having a call-back function, and more particularly, to a text or voice pager being capable of linking to at least a remote communication device via the GSM network with an automatic linking program to enable a two-way communication, based on a communication address designated in the paging (dispatching) message or pre-stored in the pager.

2. Related Art

Pagers applicable in paging systems are generally classified into text pagers and voice pagers, such as pagers widely used for the police, fire fighting, medical, rescue and military affairs. Conventional text or voice pagers receive a call alert signal (e.g. 2-tone alert signal) from a console, the pagers will automatically transmit an acknowledgement (Ack) to the console to notify the console (operator) that the paging message is being received.

Although conventional text or voice pagers as described above are capable of transmitting an Ack to the console, they cannot communicate with the console or other radio devices through voice mutually and directly as two-way communication. Therefore, conventional pagers are strictly one-way, and members (users) have to use other wireless or cable communication devices (such as radios, cell phones or wired phones) for further two-way communication. As a result, conventional pagers have the drawbacks of lacking usability.

Additionally, when receiving a paging (dispatch) message from the console, a conventional text or voice pager will automatically transmit an Ack in short message format, utilizing embedded programs, to the console via the Global System for Mobile Communications (GSM) network so as to notify operators of the console of the paging message which is received by one or multiple selected pagers. However, conventional pagers are only capable of transmitting a limited amount of information, which is not enough for successfully conveying fully information as users' expectation, or which causes members (receivers) unable to obtain more and necessary information regarding emergent events and thus affecting efficiency of dispatching.

Accordingly, for improving communication ability and usability, it is imperative to invent a text or voice pager having a call-back function, which allows each member to utilize the pager calling the console, other members, or organizations to enable a two-way communication, or which is even capable of launching or participating in a conference call or accessing an email server to retrieve paging messages.

### SUMMARY OF THE INVENTION

Accordingly, an object of the present invention is to provide a pager having a call-back function, the pager comprising a process unit which is coupled with each element in the pager, and is configured to receive a paging message from a console through a paging transceiver module, and automatically transmit an acknowledgement (Ack) to the console through a GSM or a GPRS communication module when receiving a call alert signal.

In accordance with present invention, the GSM communication module is further configured to transmit and receive a voice or/and text message in short message service (SMS) or GPRS format via a GSM/GPRS network.

In accordance with present invention, the process unit is further coupled with an audio circuit including a speaker and a microphone for producing sound and receiving sound respectively, and the process unit further comprises an automatic linking program which comprises at least one of a call back program, a conference call program, and an emergency call program for wirelessly linking the pager to at least a remote communication device via the GSM network when the automatic linking program is automatically or manually executed so as to enable a two-way communication.

In accordance with present invention, the automatic linking program enables the pager to transmit a message for requesting a call to at least a corresponding remote communication device via the GSM network, based on a communication address designated in the received paging message or pre-stored in the memory, wherein after the remote communication device in response to said message of requesting a call, the remote communication device and the pager are capable of conducting the two-way communication. The remote communication device comprises at least one of a console, voice communication devices (including communication devices used by members, a commander, a dispatch center, and an aid organization), a conference call server, and an email server.

In accordance with present invention, the pager is regularly used in a paging communication system for receiving paging messages from a console so as to economize electricity consumption and communication resources. Furthermore, after obtaining (reading or hearing) the paging messages, the pager is capable of initiating the GSM/GPRS network for enabling a one-to-one or/and one-to-many voice or text message transmission, whereby the pager is also capable of conducting a two-way communication with at least a remote communication device. Still further, the pager is capable of utilizing the conference call server to conduct a multi-party telephone conference, and accessing the email server to retrieve the paging messages so as to improve communication ability and usability.

### BRIEF DESCRIPTION OF THE DRAWINGS

FIG. 1 is a block diagram of a circuit of a pager of the present invention;

FIG. 2 is a schematic layout diagram of an embodiment of the present invention; and

FIG. 3 is a schematic layout diagram of another embodiment of the present invention.

### DESCRIPTION OF THE PREFERRED EMBODIMENTS

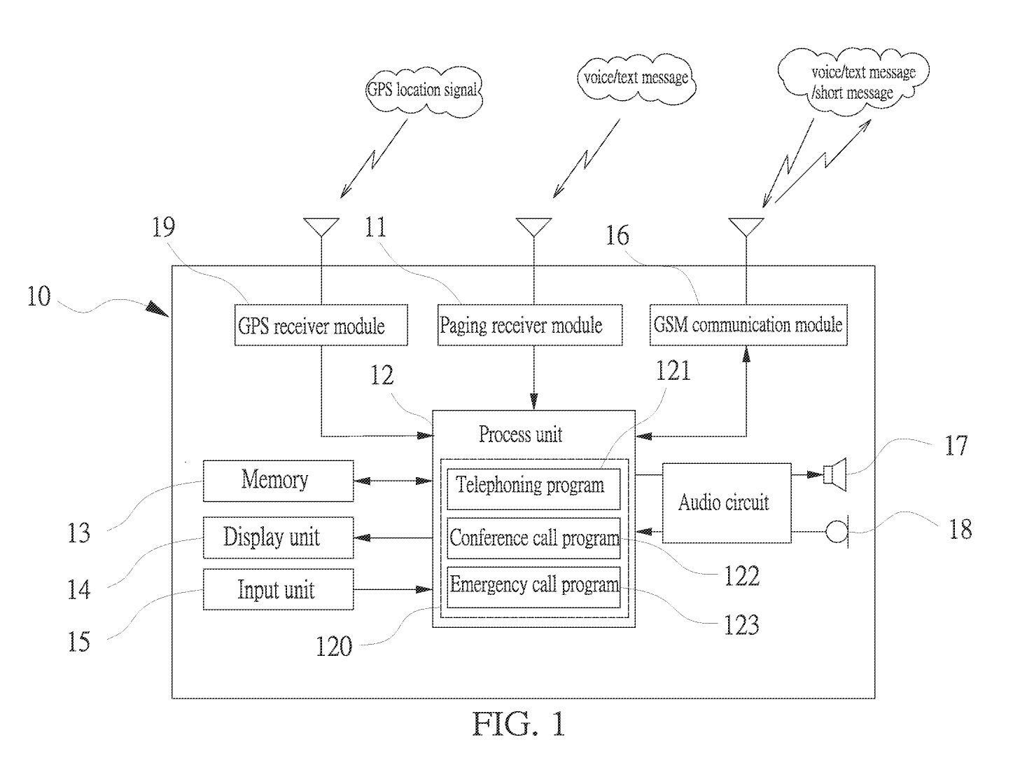

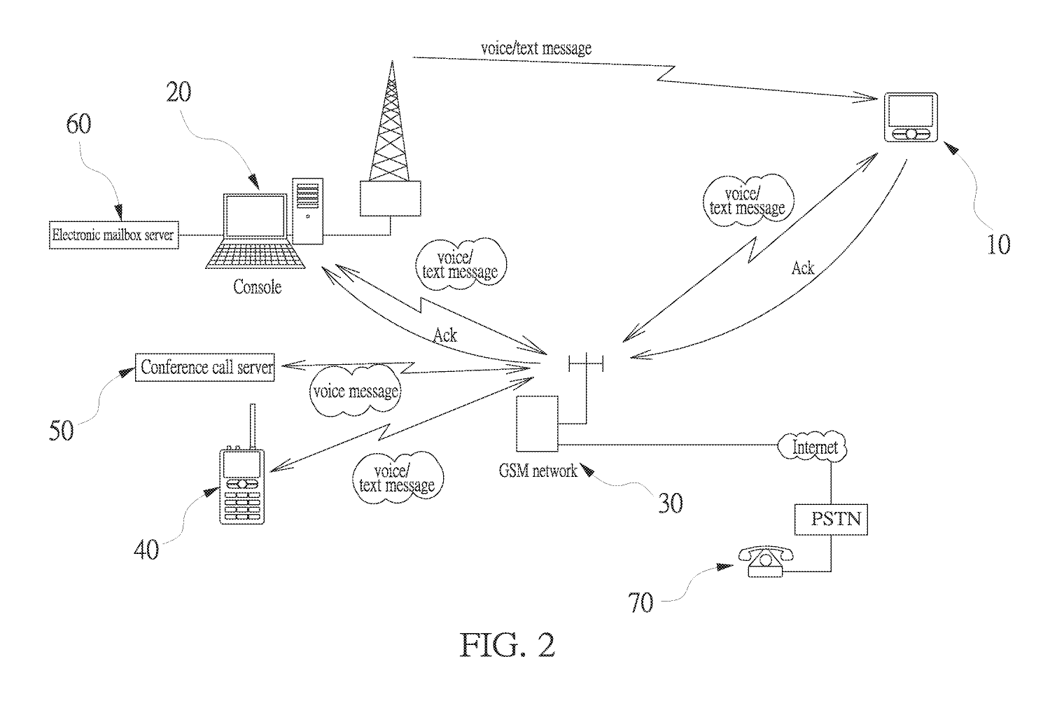

Referring to FIGS. 1 and 2, a pager having a call-back function 10 of the present invention comprises a process unit 12 coupled with a paging receiver module 11, a memory 13, a display unit 14, an input unit 15, and a Global System for Mobile Communications (GSM) communication module 16. The process unit 12 is configured to receive a paging message from a console 20 through the paging receiver module 11, and automatically transmit an acknowledgement (Ack) to the console 20 through the GSM communication module 16 when receiving a call alert signal.

The GSM communication module 16 is further configured to transmit and receive a voice or/and text message (including data) in short message service (SMS) or GPRS format via a GSM (or a GPRS) network 30.

The process unit 12 is further coupled with an audio circuit including a speaker 17 and a microphone 18 for producing sound and receiving sound respectively. The process unit 12 further comprises an automatic linking program 120 which comprises at least one of a call back program 121, a conference call program 122, and an emergency call program 123 (subprograms) for wirelessly linking the pager 10 to at least a remote communication device via the GSM network 30 when the automatic linking program 120 is automatically or manually executed with one of the selected subprograms (121, 122, and 123), so as to enable a two-way communication.

The input unit 15 has at least a specified key for manually executing the automatic linking program 120.

Referring to FIG. 2, the remote communication device comprises at least one of a console 20, other voice communication devices 40 (including communication devices used by members, a commander, a dispatch center, and an aid organization), a conference call server 50 for providing a conference call service, an email server 60, and a Public Switched Telephone Network (PSTN) telephone 70.

The automatic linking program 120 is capable of being executed by press the specified key of the input unit 15 to enable the pager 10 to transmit a message for requesting a call to at least one of the corresponding remote communication device (20, 40, 50, 60 or 70) via the GSM network 30 to realize linkage therebetween, based on a communication address designated in the received paging message or pre-stored in the memory 13 (or edited in a program), wherein the designated communication address can be selected from a work list or an address book displayed on the display unit 14. After the remote communication device in response to message of requesting a call, the remote communication device and the pager 10 are capable of conducting the two-way communication or/and transmitting text messages via the GSM network 30, according to a setting of one of the programs (121, 122, and 123) as agreed by both the remote communication device and the pager 10.

As described above, based on a communication address designated in the paging message or pre-stored in the memory 13 (or edited in a program), the call back program 121 executes the automatic linking to call the console 20 or/and one of the communication devices 40 (such as the same pagers, radio devices, or cell phones) via the GSM network 30 to realize linkage therebetween. Then the two-way communication is being conducted according to a setting of the call back program 121. Furthermore, the call back program 121 is further automatically linked to the email server 60 connected with the console 20. The email server 60 is configured to simultaneously store a paging message transmitted by the console 20 or to convert a voice message into a text message; in the event that a member fails to receive the paging message or read/hear the paging message, the member can execute the call back program 121 to directly access the email server 60 via the GSM network 30 to retrieve the paging message including text/voice messages being stored therein.

The conference call program 122, based on a communication address of a designated conference call server 50 stored in the memory 13, executes the automatic linking to call the designated conference call server 50 via the GSM network 30 to actively launch a telephone conference and conduct a multi-party conversation with more than one remote communication device 40 (including communication devices used by members, a commander, a dispatch center, and an aid organization) or/and the PSTN phone 70 through the designated conference call server 50. Furthermore, the conference call program 122 also accepts another telephone conference launched by other device of a member, a commander, a dispatch center, or a console through the designated conference call server 50 to participate in the conversation.

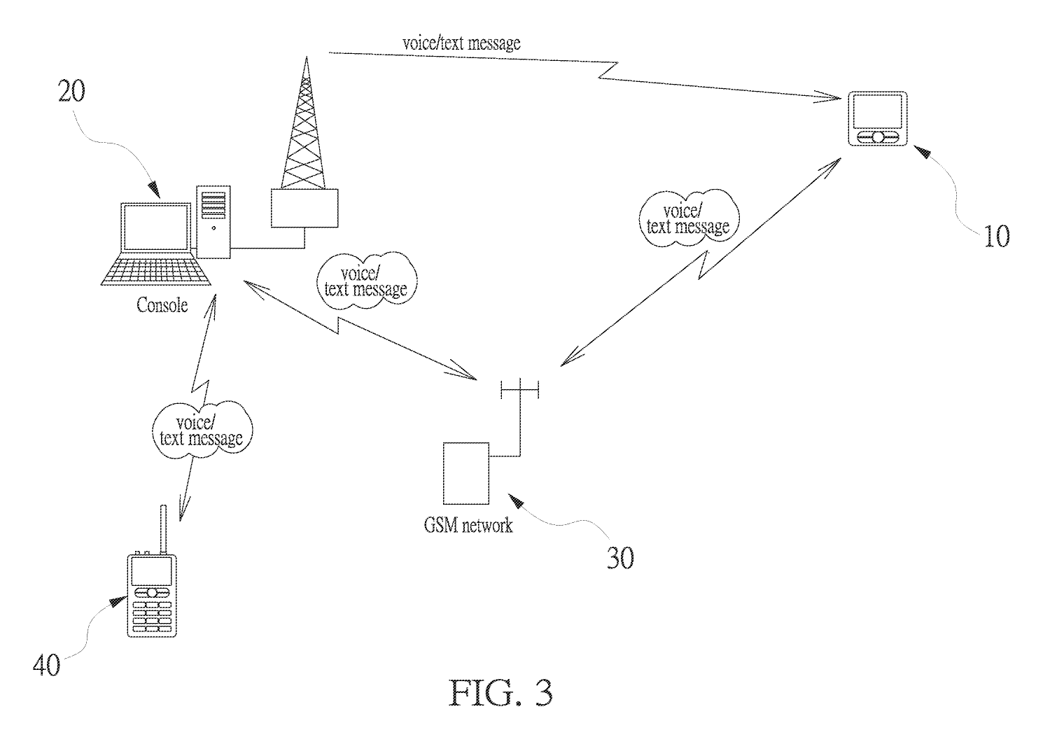

The emergency call program 123, based on a communication address of a designated console 20 (dispatch center) stored in the memory 13 (or edited in a program), executes the automatic linking program 12 to call the designated console 20 (dispatch center) for requesting an emergency conversation via the GSM network 30, wherein after receiving said request, the designated console 20 is capable of automatically or manually making a call to a voice communication device 40 as requested by the pager 10 (as shown in FIG. 3, a situation of the pager 10 fails to directly communicate with a voice communication device 40). The designated console 20 is functioned as a bridge (repeater station) for the two-way communication between the pager 10 and the voice communication device 10.

Furthermore, the pager 10 as described above further comprises a Global Positioning System (GPS) receiver module 19 (as shown in FIG. 1) for receiving coordinate information from a GPS satellite and transmitting a current coordinate information of the pager 10 to the console 20 or/and other remote communication device via the GSM network 30 at the time when the pager 10 transmits any message or executes any one of the programs (121, 122, and 123). Moreover, the coordinate information is at least displayed on a screen of the console 20 for indicating a location of the pager or member.

The pager 10 of the present invention is regularly used in a paging communication system (network) for receiving paging messages from a console so as to economize electricity consumption and communication resources. Furthermore, after obtaining (reading or hearing) the paging messages, if there is a need, the pager 10 is capable of initiating the GSM/GPRS network 30 for enabling a one-to-one or/and one-to-many voice or text message transmission, whereby an ordinary one-way pager is also capable of conducting a two-way communication with at least a remote communication device. Still further, the pager 10 utilizes the conference call server 50 to conduct a multi-party telephone conference. For example, each member can discuss with the commander how to cope with a current emergency, or the professional staff can be called to participate in the telephone conference. The pager 10 is also capable of accessing the email server 60 to retrieve the paging messages so as to improve communication ability and usability.

It is understood that the invention may be embodied in other forms within the scope of the claims. Thus the present examples and embodiments are to be considered in all respects as illustrative, and not restrictive, of the invention defined by the claims.

What is claimed is:

1. A pager having a call-back function, comprising:
a process unit coupled with a paging receiver module, a memory, a display unit, an input unit, and a Global System for Mobile Communications (GSM) communication module, the process unit configured to receive a paging message from a console through the paging receiver module, and automatically transmit an acknowledgement (Ack) to the console through the GSM communication module when receiving a call alert signal;
wherein the GSM communication module is further configured to transmit and receive a voice or/and text message in short message service (SMS) or GPRS format via a GSM network;
the process unit further coupled with an audio circuit including a speaker and a microphone for producing sound and receiving sound respectively, and the process unit further comprising an automatic linking program which comprises at least one of a call back program, a conference call program, and an emergency call program for wirelessly linking the pager to at least a remote communication device via the GSM network when the automatic linking program is automatically or manually executed so as to enable a two-way communication; and
the input unit having at least a specified key for manually executing the automatic linking program.

2. The pager of claim 1, wherein the automatic linking program enables the pager to transmit a message for requesting a call to at least a corresponding remote communication device via the GSM network, based on a communication address designated in the received paging message or pre-stored in the memory, wherein after the remote communication device in response to message of requesting a call, the remote communication device and the pager are capable of conducting the two-way communication.

3. The pager of claim 2, wherein the remote communication device comprises at least one of a console, voice communication devices, a conference call server, and an email server.

4. The pager of claim 3, wherein the call back program is further automatically linked to the console or an email server connected with the console via the GSM network, according to a communication address from the received paging message or pre-stored in the memory, wherein the email server is configured to simultaneously store a paging message transmitted by the console, so that the call back program is capable of directly accessing the email server via the GSM network to retrieve the paging message being stored therein.

5. The pager of claim 3, wherein the conference call program is automatic linking to the conference call server via the GSM network, according to a communication address from the received paging message or pre-stored in the memory, then the pager to actively launch a telephone conference and conduct a multi-party conversation with more than one remote communication device through the designated conference call server, and the conference call program of the pager accepts another telephone conference launched by other devices through the designated conference call server to participate in the conversation.

6. The pager of claim 3, wherein the emergency call program is automatic linking to the designated console for requesting an emergency call via the GSM network, wherein after receiving said request, the designated console is capable of automatically or manually making a call to a voice communication device as requested by the pager, and is functioned as a bridge for a two-way communication between the pager and the voice communication device.

7. The pager of claim 1, further comprising a Global Positioning System (GPS) receiver module for receiving coordinate information from a GPS satellite and transmitting the coordinate information of the pager to the console or/and the at least a remote communication device via the GSM network at the time when the pager transmits any message or executes the automatic linking program, wherein the coordinate information is at least displayed on a screen of the console for indicating a location of the pager.

8. The pager of claim 4, wherein the email server is configured to simultaneously store a paging message comprising at least one of a voice messaging, a text messages, and to convert a voice message into a text message.
